(19) United States
(12) Patent Application Publication
(10) Pub. No.: US 2012/0036365 A1
(43) Pub. Date: Feb. 9, 2012

(54) COMBINING REQUEST-DEPENDENT METADATA WITH MEDIA CONTENT

(75) Inventors: Fedir Yuriyovych Kyslov, Saint-Cloud (FR); Boris Borislavov Sokolov, Paris (FR); Manuel Millot, Saint-Germain-en-Laye (FR)

(73) Assignee: Microsoft Corporation, Redmond, WA (US)

(21) Appl. No.: 12/852,168

(22) Filed: Aug. 6, 2010

(51) Int. Cl. G06F 17/30; H04L 9/32

(52) U.S. Cl. 713/176; 707/769; 707/E17.014

(57) ABSTRACT

An edge component receives a request for media content from a user device. The request includes both an indication of the media content and an indication of request-dependent metadata for the media content. The edge component obtains the request-dependent metadata for the media content from a content delivery service, and obtains the media content from a content delivery network. The edge component combines the request-dependent metadata and the media component, returning both the request-dependent metadata and the media content to the user device.

### BACKGROUND

Allowing users to obtain media content over a network, such as the Internet, has become increasingly commonplace. While obtaining media content over a network is convenient for users, it is not without its problems. One such problem is that media content is oftentimes stored as different files on one or more servers. Situations can arise where, in response to requests from users for the same media content, different files are provided to the different users in response to the requests. Maintaining and/or generating these different files can be a time-intensive and/or resource-intensive task.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request for media content is received from a user device. The request includes both an indication of the media content and an indication of request-dependent metadata for the media content. The request-dependent metadata for the media content is obtained from a first source, and the media content is obtained from a second source. Both the request-dependent metadata and the media content are returned to the user device.

In accordance with one or more aspects, a service receives an indication of request-dependent metadata for media content from an edge component that receives a request from a user device for the media content. Based on the indication, the service obtains the request-dependent metadata for the media content and returns the request-dependent metadata to the edge component, the edge component receiving the media content from a source separate from the service.

### BRIEF DESCRIPTION OF THE DRAWINGS

The same numbers are used throughout the drawings to reference like features.

FIG. 1 illustrates an example system implementing the combining request-dependent metadata with media content in accordance with one or more embodiments.

FIG. 2 is a flowchart illustrating an example process for a commerce service receiving and responding to requests for media content in accordance with one or more embodiments.

FIG. 3 is a flowchart illustrating an example process for an edge component receiving and responding to requests for media content in accordance with one or more embodiments.

FIG. 4 is a flowchart illustrating an example process for a content delivery service receiving and responding to requests for request-dependent metadata in accordance with one or more embodiments.

FIG. 5 illustrates an example computing device that can be configured to implement the combining request-dependent metadata with media content in accordance with one or more embodiments.

### DETAILED DESCRIPTION

Combining request-dependent metadata with media content is discussed herein. A user device communicates a request for particular media content to a commerce service, and in return receives from the commerce service a content delivery Uniform Resource Locator (URL) for the requested media content. Embedded in the content delivery URL is an indication of the media content and also an indication of request-dependent metadata for the media content. This request-dependent metadata for the media content can be different for each different request that user devices make to the commerce server for the same media content.

The user device provides the received content delivery URL to an edge component of a content delivery network. The edge component provides the content delivery URL to a content delivery service, which obtains the indicated request-dependent metadata and returns the request-dependent metadata to the edge component. The edge component also obtains the media content indicated in the content URL from the content delivery network. The edge component combines the request-dependent metadata and the media content, returning both the request-dependent metadata and the media content to the user device (e.g., as a single media file).

References are made herein to symmetric key cryptography, public key cryptography and public/private key pairs. Although such key cryptography is well-known to those skilled in the art, a brief overview of such cryptography is included here to assist the reader. In public key cryptography, an entity (such as a user, hardware or software component, a device, a domain, and so forth) has associated with it a public/private key pair. The public key can be made publicly available, but the entity keeps the private key a secret. Without the private key it is computationally very difficult to decrypt data that is encrypted using the public key. So, data can be encrypted by any entity with the public key and only decrypted by an entity with the corresponding private key. Additionally, a digital signature for data can be generated by using the data and the private key. Without the private key it is computationally very difficult to create a signature that can be verified using the public key. Any entity with the public key can use the public key to verify the digital signature by executing a suitable digital signature verification algorithm on the public key, the signature, and the data that was signed.

In symmetric key cryptography, on the other hand, a shared key (also referred to as a symmetric key) is known by and kept secret by the two entities. Any entity having the shared key is typically able to decrypt data encrypted with that shared key. Without the shared key it is computationally very difficult to decrypt data that is encrypted with the shared key. So, if two entities both know the shared key, each can encrypt data that can be decrypted by the other, but other entities cannot decrypt the data if the other entities do not know the shared key. Similarly, an entity with a shared key can encrypt data that can be decrypted by that same entity, but other entities cannot decrypt the data if the other entities do not know the shared key. Additionally, symmetric key cryptography can be used as a basis for generating a digital signature for data. For example, a trusted third party can generate a symmetric key based on an identity of a particular entity, and then can both create and verify digital signatures for that particular entity (e.g., by encrypting or decrypting the data using the symmetric key).

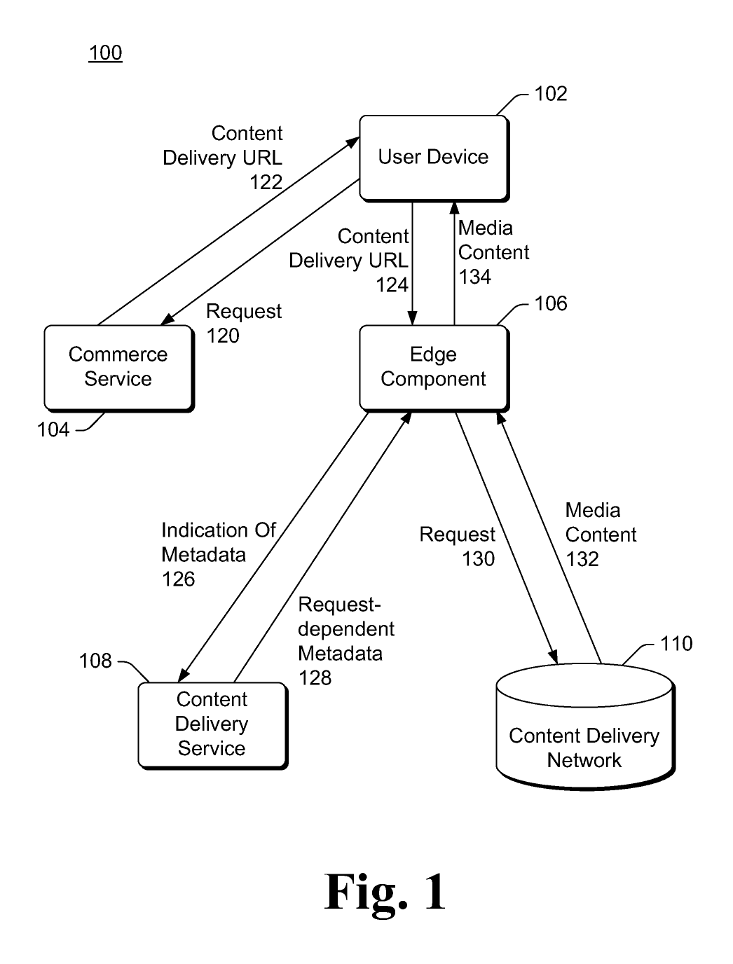

FIG. 1 illustrates an example system 100 implementing the combining request-dependent metadata with media content in accordance with one or more embodiments. System 100 includes a user device 102, a commerce service 104, an edge component 106, a content delivery service 108, and a content delivery network 110. User device 102 can communicate with commerce service 104 and edge component 106, and edge component 106 can communicate with content delivery service 108 and content delivery network 110. Such communication can be performed via a variety of different networks, such as the Internet, a local area network (LAN), a public telephone network, an intranet, other public and/or proprietary networks, combinations thereof, and so forth. Such communication can also be performed using other protocols or technologies, such as universal serial bus (USB) connections, wireless USB connections, infrared connections, Bluetooth connections, and so forth.

User device 102 can be a variety of different types of computing devices. For example, user device 102 can be a desktop computer, a notebook computer, a notepad or tablet computer, a mobile station, an entertainment appliance, a set-top box communicatively coupled to a display device, a television, an audio and/or video playback device, a cellular or other wireless phone, a game console, an automotive computer, and so forth.

Each of commerce service 104, edge component 106, and content delivery service 108 are implemented as one or more computing devices. Analogous to user device 102, a variety of different types of computing devices can be used to implement commerce service 104, edge component 106, and content delivery service 108. Commerce service 104, edge component 106, and content delivery service 108 are typically implemented by different computing devices, although alternatively one or more of commerce service 104, edge component 106, and content delivery service 108 can be implemented using the same computing device.

Content delivery network 110 stores media content. Although content delivery network 110 is illustrated as being separate from edge component 106, edge component 106 can alternatively be included as part of content delivery network 110. A variety of different types of media content can be stored by content delivery network 110, such as audio content, video content, audio/video content, computing device applications or programs, and so forth. Content delivery network 110 can use a variety of different techniques and/or structures to store media content. In one or more embodiments, content delivery network 110 employs a tree-based structure in which servers are implemented at multiple different levels. A copy of the media content is stored at a root or base level. At one or more higher levels of the tree-based structure, additional copies of the media content are stored. Typically, at each level of the tree-based structure there are more servers in different physical locations (e.g., distributed throughout the world) than at the next lower level, but the servers at each level of the tree-based structure also typically store less media content than the servers at the next lower level. Thus, servers at a higher level in content delivery network 110 are typically closer to the user devices than servers at lower levels, but also store less media content than servers at lower levels. If requested media content is not available from a server at a higher level, then the media content is obtained from a server at a lower level.

Alternatively, structures other than tree-based structures can be used by content delivery network 110. It should be noted that any of a variety of different structures or techniques can be used to implement content delivery network 110.

Content delivery network 110 is accessed by way of edge component 106. In one or more embodiments, media content in content delivery network 110 can only be accessed via edge component 106. Requests for media content received by a server in content delivery network 110 from devices or components other than edge component 106 are ignored by content delivery network 110, and any such requested media content is not returned to the requestor by content delivery network 110. The media content is stored by content delivery network 110 in a secure manner, ensuring that the media content can only be accessed via edge component 106. For example, address filtering can be employed to ensure that requests for content from edge component 106 (having one or more network addresses known to content delivery network 110) are responded to with the requested media content but requests from other components or devices are ignored.

It should also be noted that although a single user device 102 is illustrated in system 100, multiple user devices can be included in system 100. Additionally, it should be noted that although a single edge component 106, content delivery network 110, commerce service 104, and content delivery service 108 are illustrated in system 100, multiple edge components 106, content delivery networks 110, commerce services 104, and/or content delivery services 108 can be included in system 100.

During operation of system 100, user device 102 requests particular media content. The request can originate, for example, from a user of user device 102 and/or a component or module of user device 102. The particular media content can be identified in different manners, such as user selection of particular media content from a list of media content, selection of particular media content by a component or module of user device 102, and so forth. User device 102 sends a request 120 for the particular media content to commerce service 104. Request 120 can include an identifier of the particular media content, or alternatively the particular media content can be inherent in request 120 (e.g., a user selection of particular media content via a user interface presented by commerce service 104).

In response to request 120, commerce service 104 determines whether user device 102 is permitted to access the requested media content. Commerce service 104 controls whether media content can be provided to user device 102 from content delivery network 110. This determination can be performed in a variety of different manners. In one or more embodiments, user device 102 is permitted to access the requested media content if a user of user device 102 is authenticated (e.g., by way of a user ID and password, a digital certificate, a passcode, etc. provided by the user) by commerce service 104 and/or pays a fee (e.g., to commerce service 104). Alternatively, user device 102 is permitted to access the requested media content if user device 102 is authenticated (e.g., by way of a digital certificate, an identifier stored on (or generated by) user device 102, and so forth). In one or more embodiments, commerce service 104 maintains or otherwise has access to a record of information (e.g., user IDs and passwords, passcodes, digital certificates, etc.) that commerce service 104 uses to authenticate user device 102 and/or the user of device 102.

If commerce service 104 determines that user device 102 is not permitted to access the requested media content, then commerce service 104 returns an indication to user device 102 that the request is denied. Alternatively, commerce service 104 can ignore request 120 and provide no response to user device 102.

However, if commerce service 104 determines that user device 102 is permitted to access the requested media content, then commerce server 104 generates a content delivery URL 122 and returns content delivery URL 122 to user device 102. Commerce server 104 can also optionally return to user device 102 additional information regarding negotiated protocols between user device 102 and commerce server 104, or other information to be used by user device 102 in obtaining and/or playing back the media content.

Content delivery URL 122 includes both an indication of the requested media content and an indication of request-dependent metadata for the media content. The indication of the requested media content identifies the media content within content delivery network 110. This indication of the media content can be, for example, a link or pointer to a location where the media content is stored, an alphanumeric identifier (e.g., a GUID (globally unique identifier) that uniquely identifies the media content within content delivery network 110), and so forth.

The indication of the media content in content delivery URL 122 can also optionally be encrypted in a manner that allows the indication to be decrypted by edge component 106 and/or content delivery network 110. The indication of the media content can be encrypted in different manners, such as using a public key of edge component 106 and/or content delivery network 110, using a symmetric key known to edge component 106 and/or content delivery network 110, and so forth. The indication of the media content in content delivery URL 122 can also optionally be digitally signed (e.g., by commerce service 104), allowing edge component 106 and/or content delivery network 110 to verify that the indication of the media content was provided by commerce service 104 and/or that the indication of the media content was not altered after generation of the digital signature. The indication of the media content can be digitally signed in different manners, such as using a public key of edge component 106 and/or content delivery network 110, using a symmetric key known to edge component 106 and/or content delivery network 110, and so forth.

The indication of request-dependent metadata identifies metadata that is specific to the particular request 120 received from user device 102. The request-dependent metadata is customized to the particular request 120 or transaction (which refers to user device 102 requesting and receiving particular media content). This customization can include, for example, including information identifying the particular user device 102 or user of device 102, including information (such as genre or other information describing the media content) in a particular language based on the location of user device 102, and so forth.

Different requests can have different associated request-dependent metadata, such as user-dependent metadata (e.g., a user ID of the user of device 102 making the request), transaction identification metadata (e.g., an identifier (also referred to as a transaction ID) of request 120 or timestamp of the request), location-dependent metadata (e.g., a country in which user device 102 is located, genre or other information in a language spoken in the country in which user device 102 is located), content identification metadata (e.g., an identifier of content in content delivery network 110), and so forth. Commerce service 104 generates or otherwise obtains (e.g., from another device or service) at least part of the request-dependent metadata for each request for the media content.

This indication of the request-dependent metadata can also optionally be encrypted in a manner that allows the indication to be decrypted by edge component 106 and/or content delivery service 108. The indication of the request-dependent metadata can be encrypted in different manners, such as using a public key of edge component 106 and/or content delivery service 108, using a symmetric key known to edge component 106 and/or content delivery service 108, and so forth. This indication of the request-dependent metadata can also optionally be digitally signed (e.g., by commerce service 104), allowing edge component 106 and/or content delivery service 108 to verify that the indication of the request-dependent metadata was provided by commerce service 104 and/or that the indication of the request-dependent metadata was not altered after generation of the digital signature. The indication of the request-dependent metadata can be digitally signed in different manners, such as using a public key of edge component 106 and/or content delivery service 108, using a symmetric key known to edge component 106 and/or content delivery service 108, and so forth.

In one or more embodiments, the request-dependent metadata includes a user ID that identifies the user of device 102, a transaction ID that identifies the current transaction, a product ID that identifies the media content being requested in the current transaction, a delivery date that identifies a date and/or time for the current transaction (e.g., a date and/or time of when request 120 is received, when access to the media content is determined by commerce service 104 to be permitted, when commerce service 104 is obtaining the metadata, when content delivery URL 122 is returned to user device 102, etc.), and a cryptographic hash of the media content (e.g., generated by commerce service 104, generated by another source and obtained by or otherwise provided to commerce service 104, etc.). Commerce service 104 also generates a digital signature for the user ID, transaction ID, product ID, delivery date, and cryptographic hash, and includes the digital signature in the request-dependent metadata. Alternatively, the digital signature can be generated elsewhere (e.g., by content delivery service 108 as discussed in more detail below).

In one or more embodiments, commerce service 104 maintains a record of the request-dependent metadata for each request for the media content. This record can be maintained in a variety of different manners, such as in a database that is maintained by or is otherwise accessible to commerce service 104. The indication of the request-dependent metadata for a particular request for the media content that is included in content delivery URL 122 is information identifying the record of the request-dependent metadata for the media content. This indication can be parts of the request-dependent metadata (e.g., both the user ID and the transaction ID), or alternatively a separate identifier (e.g., an alphanumeric identifier for the record that uniquely identifies the record within the database). Alternatively, the indication of the request-dependent metadata for the media content that is included in content delivery URL 122 can be the request-dependent metadata itself (optionally encrypted as discussed above).

In one or more embodiments, both the indication of the requested media content and the indication of the request-dependent metadata for the media content are embedded in the content delivery URL 122. Alternatively, the indication of the requested media content and the indication of the request-dependent metadata for the media content can be communicated to user device 102 in other manners. For example, the indication of the requested media content and the indication of the request-dependent metadata for the media content can be communicated to user device 102 in a separate message or other data structure separate from content delivery URL 122, a link to or other indication of where to obtain content delivery URL 122 or information from which content delivery URL 122 can be generated can be communicated to user device 102, and so forth.

Additionally, although referred to as a URL, the indication of the requested media content and/or the indication of the request-dependent metadata for the media content returned to user device 102 can be in different formats than a URL. For example, the indication of the requested media content and/or the indication of the request-dependent metadata for the media content can be communicated from commerce service 104 to user device 102 using different data structures other than a URL.

User device 102 receives content delivery URL 122 and in response sends content delivery URL 124 to edge component 106. Content delivery URL 124 is typically content delivery URL 122 received from commerce service 104, although alternatively content delivery URL can be generated from other information received by user device 102. Analogous to content delivery URL 122, content delivery URL 124 includes both an indication of the requested media content and an indication of request-dependent metadata for the media content. In one or more embodiments, content delivery URL 122 includes an indication or identifier of edge component 106. For example, content delivery URL 122 can be a URL that resolves to a network address (e.g., Internet Protocol (IP) address) of edge component 106. Alternatively, user device 102 can obtain an indication of edge component 106 in other manners, such as in a separate communication from commerce service 104, from another device or service with which user device 102 communicates, and so forth.

Edge component 106 receives content delivery URL 124 and sends at least part of content delivery URL 124 to content delivery service 108. In one or more embodiments edge component 106 sends at least the indication of the request-dependent metadata 126 for the media content to content delivery service 108, although additional information can optionally be sent to content delivery service 108 as well. The indication of the request-dependent metadata 126 is the indication of the request-dependent metadata 126 included in content delivery URL 124.

Content delivery service 108 uses the indication of the request-dependent metadata 126 to retrieve, generate, or otherwise obtain request-dependent metadata for the media content that is being requested by user device 102. In one or more embodiments, content delivery service 108 has access to the record of the request-dependent metadata for each request that is maintained by commerce service 104. Content delivery service 108 thus uses the indication of the request-dependent metadata 126 to retrieve the record of the request-dependent metadata that was generated by commerce service 104. Alternatively, content delivery service 108 can obtain the request-dependent metadata in other manners. For example, if the request-dependent metadata is included in encrypted form in the indication of the request-dependent metadata 126, then content delivery service 108 can obtain the request-dependent metadata by decrypting the request-dependent metadata.

Content delivery service 108 can retrieve request-dependent metadata (e.g., from a record or other database, by decrypting the received indication of the request-dependent metadata, from other information received from edge component 106 (as part of the indication of the request-dependent metadata 126 or otherwise provided by edge component 106), etc.), and/or generate at least part of the request-dependent metadata. For example, content delivery service 108 can retrieve part of the request-dependent metadata from a record stored by commerce service 104, digitally sign the retrieved part, and return the digital signature and retrieved part of the request-dependent metadata together as the request-dependent metadata for the media content. By way of another example, content delivery service 108 can retrieve part of the request-dependent metadata from a record stored by commerce service 104, determine from the retrieved part a language used in the locale where user device 102 is located, retrieve a translation of part of the request-dependent metadata to that language (e.g., from a database or other service accessible to content delivery service 108), and return the translated part of the request-dependent metadata as the request-dependent metadata for the media content.

Regardless of the manner in which content delivery service 108 obtains the request-dependent metadata, service 108 returns the request-dependent metadata 128 to edge component 106. Request-dependent metadata 128 can optionally be digitally signed by content delivery service 108 or alternatively an external third party service. Thus, edge component 106 need not be concerned with obtaining the request-dependent metadata because content delivery service 108 provides the request-dependent metadata to edge component 106.

Edge component 106 also obtains the requested media content, using the indication of the requested media content in content delivery URL 124, from content delivery network 110. Edge component 106 obtains the media component by communicating a request 130 to content delivery network 110 and receiving the media content 132 in response to request 130. The manner in which edge component 106 obtains the requested media content can vary based on the manner in which content delivery network 110 is implemented. For example, content delivery URL 124 can include an alphanumeric identifier of the content and edge component 106 can retrieve a file including the media content that is identified by that alphanumeric identifier from a cache or server in content delivery network 110.

Edge component 106 combines the request-dependent metadata 128 and the media content 132, and returns the combined request-dependent metadata 128 and media content 132 to user device 102 as the requested media content 134. The manner in which request-dependent metadata 128 and media content 132 are combined can vary based on the media content format and/or protocol being used in system 100. For example, the request-dependent metadata 128 and media content 132 can be combined by edge component 106 adding the request-dependent metadata 128 to a header of the file that includes media content 132. By way of another example, the request-dependent metadata 128 and media content 132 can be combined by edge component 106 interspersing data packets that include request-dependent metadata 128 among data packets that include media content 132 being sent to user device 102. In one or more embodiments, edge component 106 sends request-dependent metadata 128 to user device 102 as part of media content 134 prior to sending the media content 132 obtained from content delivery network 110. Alternatively, edge component 106 can begin sending the media content 132 obtained from content delivery network 110 before sending the request-dependent metadata.

In one or more embodiments, media content 134 is returned to user device 102 as a single file (e.g., a single media file such as an MP3 file, a Windows Media® audio file, an MP4 file, a Windows Media® video file, etc.) that can be stored and/or otherwise manipulated at user device 102. Alternatively, media content 134 can be streamed to user device 102, typically allowing playback or running of media content 134 while user device 102 is in communication with edge component 106.

In one or more embodiments, edge component 106 sends the indication of request-dependent metadata 126 to content delivery service 108 and begins obtaining the media content 132 from content delivery network 110 asynchronously or concurrently. Edge component 106 need not, but alternatively could, wait to receive one of request-dependent metadata 126 or the media content 132 before obtaining the other.

Although one edge component 106 and one content delivery service 108 are illustrated in FIG. 1, it should be noted that system 100 can include multiple edge components 106 and/or multiple content delivery services 108. For example, a single content delivery service 108 can support multiple edge components 106, optionally providing request-dependent metadata in different formats or using different protocols for the different edge components 106. Similarly, a single edge component 106 can support multiple content delivery services 108, optionally receiving request-dependent metadata in different formats or using different protocols for the different content delivery services 108.

Thus, edge component 106 combines the request-dependent metadata 128 obtained from content delivery service 108 and the media content 132 obtained from content delivery network 110. Content delivery network 110 need not be concerned with the request-dependent metadata 128 for each request for media content from user device 102. Rather, content delivery network 110 can return the same media content file for each request for the media content even though the request-dependent metadata changes. Similarly, commerce service 104 and content delivery service 108 need not be concerned with storing media content files and/or including request-dependent metadata in media content files. Rather, content delivery service 108 can simply return the request-dependent metadata 128 to edge component 106, relying on content delivery network 110 to store the media content file and edge component 106 to combine the request-dependent metadata with the media content.

It should also be noted that different companies, businesses, or other entities can be responsible for maintaining the request-dependent metadata and the media content. Thus, one company, business, or entity can implement commerce service 104 and content delivery service 108 without concern for implementing storage and retrieval of the media content. Similarly, another company, business, or entity can implement content delivery network 110 without concern for implementing storage and retrieval of the request-dependent metadata.

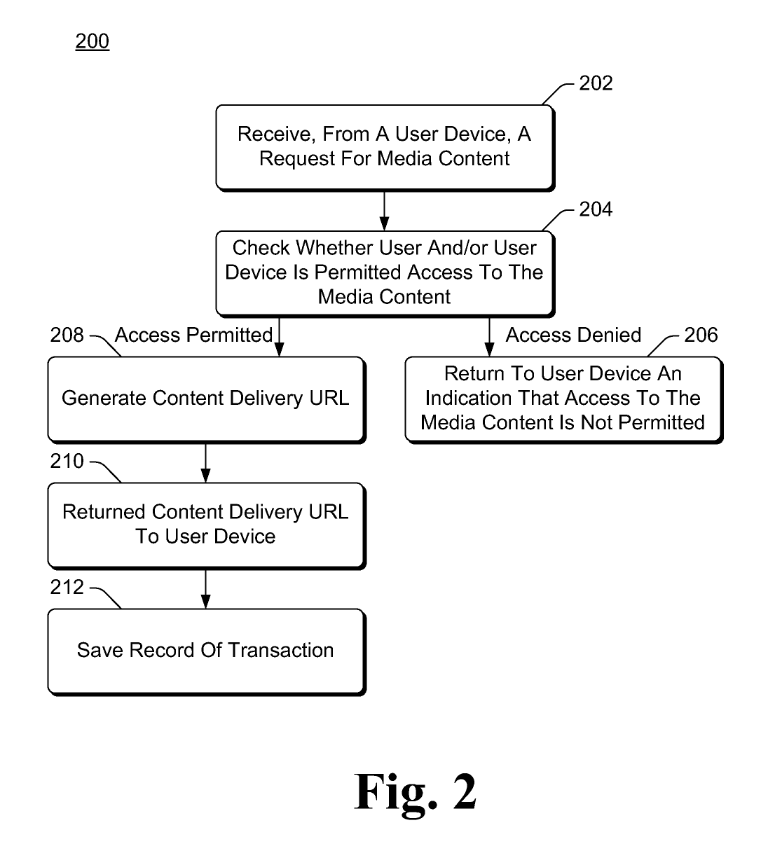

FIG. 2 is a flowchart illustrating an example process 200 for a commerce service receiving and responding to requests for media content in accordance with one or more embodiments. Process 200 is carried out by a commerce service, such as commerce service 104 of FIG. 1, and can be implemented in software, firmware, hardware, or combinations thereof. Process 200 is shown as a set of acts and is not limited to the order shown for performing the operations of the various acts. Process 200 is an example process for a commerce service receiving and responding to requests for media content; additional discussions of a commerce service receiving and responding to requests for media content are included herein with reference to different figures.

In process 200, a request for media content is received from a user device (act 202). This request can be initiated by, for example, a user of the user device or another component or module of the user device as discussed above.

In response to the request, the commerce service checks whether the user and/or user device is permitted access to the media content (act 204). This determination can be performed in a variety of different manners as discussed above.

If the user and/or user device is not permitted access to the media content, then an indication is returned to the user device that access to the media content is not permitted (act 206). Alternatively, the request can be ignored and no response returned to the user device.

However, if the user and/or user device is permitted access to the media content, then a content delivery URL is generated (act 208) and returned to the user device (act 210). The content delivery URL includes both an indication of the requested media content and an indication of request-dependent metadata for the media content as discussed above.

Additionally, a record of the transaction is saved (act 212). This record of the transaction includes various request-dependent metadata for the requested media content, as discussed above.

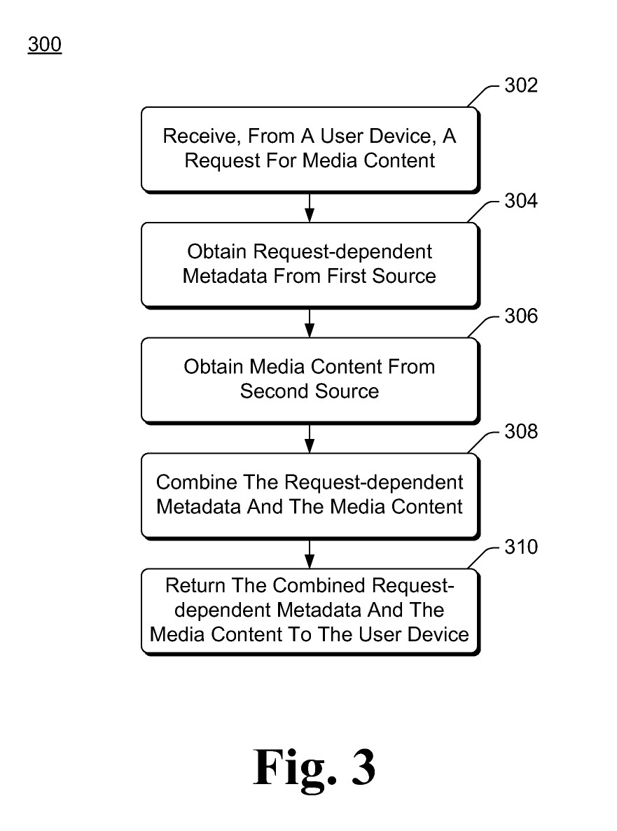

FIG. 3 is a flowchart illustrating an example process 300 for an edge component receiving and responding to requests for media content in accordance with one or more embodiments. Process 300 is carried out by an edge component, such as edge component 106 of FIG. 1, and can be implemented in software, firmware, hardware, or combinations thereof. Process 300 is shown as a set of acts and is not limited to the order shown for performing the operations of the various acts. Process 300 is an example process for an edge component receiving and responding to requests for media content; additional discussions of an edge component receiving and responding to requests for media content are included herein with reference to different figures.

In process 300, the edge component receives a request for media content from a user device (act 302). This request is typically a content delivery URL as discussed above.

The edge component obtains request-dependent metadata for the requested media content from a first source (act 304). This first source is, for example, a content delivery service 108 of FIG. 1.

The edge component also obtains the requested media content from a second source (act 306). This second source is, for example, content delivery network 110 of FIG. 1.

The edge component combines the obtained request-dependent metadata and the obtained media content (act 308). This combining can be, for example, adding the request-dependent metadata to a header of the media content as discussed above.

The combined request-dependent metadata and media content are returned to the user device (act 310). As the request-dependent metadata is different for different requests, the combined request-dependent metadata and media content returned by the edge component are different for different requests even though the media content may be the same.

As discussed above, the content delivery URL received in act 302 includes the indication of the request-dependent metadata and the indication of the media content. In one or more embodiments, these indications are encrypted or digitally signed, in which case the edge component obtains the request-dependent metadata from content delivery service 108 only if the indication of the request-dependent metadata is successfully decrypted or the digital signature is verified, and obtains the media content from content delivery network 110 only if the indication of the media content is successfully decrypted or the digital signature is verified.

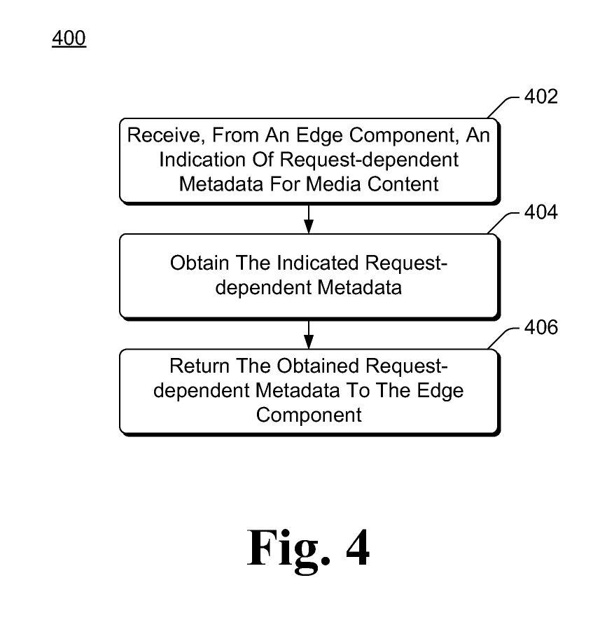

FIG. 4 is a flowchart illustrating an example process 400 for a content delivery service receiving and responding to requests for request-dependent metadata in accordance with one or more embodiments. Process 400 is carried out by a content delivery service, such as content delivery service 108 of FIG. 1, and can be implemented in software, firmware, hardware, or combinations thereof. Process 400 is shown as a set of acts and is not limited to the order shown for performing the operations of the various acts. Process 400 is an example process for a content delivery service receiving and responding to requests for request-dependent metadata; additional discussions of a content delivery service receiving and responding to requests for request-dependent metadata are included herein with reference to different figures.

In process 400, an indication of request-dependent metadata for media content is received from an edge component (act 402). This indication can take a variety of different forms as discussed above.

The indicated request-dependent metadata is obtained (act 404). The indicated request-dependent metadata can be obtained in different manners as discussed above, such as by being retrieved from and/or generated based on a record (e.g., a record generated by a commerce service such as commerce service 104 of FIG. 1).

The obtained request-dependent metadata is returned to the edge component (act 406). In one or more embodiments, the indication of the request-dependent metadata received in act 402 is digitally signed, and the content delivery service can obtain and/or return the indicated request-dependent metadata only if the digital signature is verified.

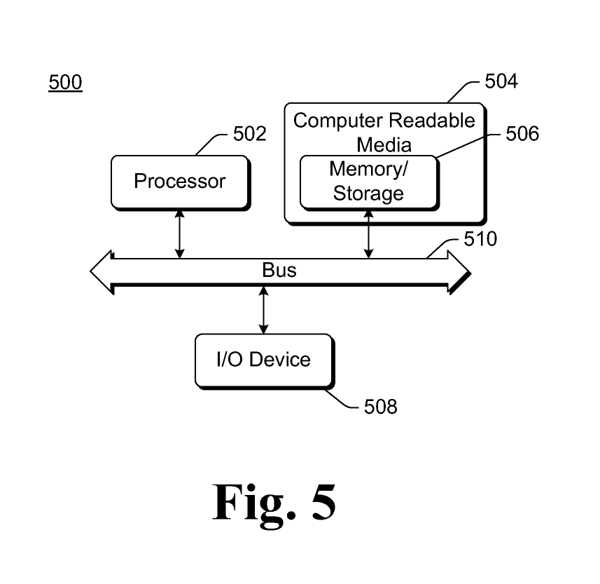

FIG. 5 illustrates an example computing device 500 that can be configured to implement the combining request-dependent metadata with media content in accordance with one or more embodiments. Computing device 500 can be, for example, user device 102 of FIG. 1, or can implement at least part of commerce service 104, edge component 106, content delivery service 108, and/or content delivery network 110 of FIG. 1.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the combining request-dependent metadata with media content techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented at least in part in a device, the method comprising:
receiving, from a user device, a request for media content, the request including both an indication of the media content and an indication of request-dependent metadata for the media content;
obtaining, from a first source, the request-dependent metadata for the media content;
obtaining, from a second source, the media content; and
returning both the request-dependent metadata and the media content to the user device.

2. A method as recited in claim 1, wherein the request-dependent metadata includes a user ID that identifies a user of the user device, a transaction ID that identifies a current transaction in which the media content is requested, a product ID that identifies the media content being requested in the current transaction, a delivery date that identifies one or both of a date and a time for the current transaction, and a cryptographic hash of the media content.

3. A method as recited in claim 1, wherein the metadata comprises genre information in a language determined based on a location of the user device.

4. A method as recited in claim 1, wherein the indication of the request-dependent metadata was obtained by the user device from a commerce service that generates at least part of the request-dependent metadata and maintains a record of at least the part of the request-dependent metadata that is accessible to the first source.

5. A method as recited in claim 4, wherein at least the part of the request-dependent metadata is digitally signed by the first source.

6. A method as recited in claim 1, wherein the second source comprises a content delivery network.

7. A method as recited in claim 1, wherein the media content is stored in a secure manner by the second source and is accessible to the user device only via the device.

8. A method as recited in claim 1, further comprising performing the obtaining the request-dependent metadata and the media content concurrently.

9. A method as recited in claim 1, further comprising combining the request-dependent metadata with the media content by adding the request-dependent metadata to a header of a file including the media content, and wherein the returning comprises returning the combined request-dependent metadata and media content to the user device.

10. A method as recited in claim 1, wherein the request comprises a content delivery uniform resource locator (URL).

11. A method as recited in claim 10, wherein the content delivery URL includes an encrypted indication of the request-dependent metadata that is both a user ID that identifies a user of the user device and a transaction ID that identifies a current transaction in which the media content is requested.

12. A method as recited in claim 11, wherein the indication of the request-dependent metadata is decrypted by the first source.

13. One or more computer storage media having stored thereon multiple instructions that, when executed by one or more processors of a service, cause the one or more processors to:
receive, from an edge component that receives a request from a user device for media content, an indication of request-dependent metadata for the media content;
obtain, based on the indication, the request-dependent metadata for the media content; and
return the request-dependent metadata for the media content to the edge component, the edge component receiving the media content from a source separate from the service.

14. One or more computer storage media as recited in claim 13, wherein to obtain the request-dependent metadata is to retrieve, based on the indication, a record of metadata from a database, digitally sign the retrieved metadata, and return the digitally signed retrieved metadata as the request-dependent metadata for the media content.

15. One or more computer storage media as recited in claim 13, wherein to obtain the request-dependent metadata is to decrypt the indication, and wherein to return the request-dependent metadata is to return the decrypted indication as the request-dependent metadata.

16. One or more computer storage media as recited in claim 13, wherein the request-dependent metadata comprises a user ID that identifies a user of the user device, a transaction ID that identifies a current transaction in which the media content is requested, a product ID that identifies the media content being requested in the current transaction, a delivery date that identifies one or both of a date and a time for the current transaction, and a cryptographic hash of the media content.

17. One or more computer storage media as recited in claim 13, wherein the indication of the request-dependent metadata is a portion of a content delivery uniform resource locator (URL) received by the edge component from the user device.

18. One or more computer storage media as recited in claim 17, wherein the indication of the request-dependent metadata comprises both a user ID that identifies a user of the user device and a transaction ID that identifies a current transaction in which the media content is requested.

19. One or more computer storage media as recited in claim 17, wherein the multiple instructions further cause the one or more processors to decrypt the indication, and wherein to obtain the request-dependent metadata is to obtain, based on the decrypted indication, the request-dependent metadata.

20. A method implemented in a commerce service, the method comprising:
receiving, from a user device, a request for media content;
checking whether one or both of the user device and a user of the user device is permitted access to the media content;
generating, if access to the media content is permitted, a content delivery uniform resource locator (URL), wherein the content delivery URL includes both an indication of the media content and an encrypted indication of request-dependent metadata for the media content, wherein the encrypted indication of request-dependent metadata comprises both a user ID that identifies the user of the user device and a transaction ID that identifies a current transaction in which the media content is requested, and wherein the request-dependent metadata comprises the user ID, the transaction ID, a product ID that identifies the media content being requested in the current transaction, a delivery date that identifies one or both of a date and a time for the current transaction, and a cryptographic hash of the media content;
returning the content delivery URL to the user device; and
saving a record of the request-dependent metadata that is accessible, based on both the user ID and the transaction ID, to a content delivery service.
